(19) United States
(12) Patent Application Publication
(10) Pub. No.: US 2014/0122290 A1
(43) Pub. Date: May 1, 2014

(54) METHODS & APPARATUS TO SELECT OPTIMUM PROMOTIONAL GIVEAWAY OR GIFT

(71) Applicant: Gerald McLaughlin, San Mateo, CA (US)

(72) Inventor: Gerald McLaughlin, San Mateo, CA (US)

(21) Appl. No.: 13/833,768

(22) Filed: Mar. 15, 2013

Related U.S. Application Data
(60) Provisional application No. 61/719,926, filed on Oct. 29, 2012.

(51) Int. Cl. G06Q 30/00

(52) U.S. Cl. CPC G06Q 30/00
USPC 705/26.7

(57) ABSTRACT

Various embodiments include a method comprising presenting selected gifts based on a multi-dimensional set of parameters, wherein each parameter within the multi-dimensional set of parameters is assigned a grade or scoring value for a given product.

### CROSS REFERENCE TO RELATED APPLICATION

This application claims the benefit of priority under 35 U.S.C. §119(e) to U.S. Provisional Application Ser. No. 61/719,926, filed Oct. 29, 2012, the entire contents of which is incorporated herein by reference in its entirety.

### BACKGROUND

A gift is often an object or a service, or in some instances an entitlement to an object or a service (such as a gift certificate or a card that has a stored value associated with the card), that is given generally without charge by one party, such as a person or persons, or an entity such as a business, to another party, such as another person or persons or another entity. In most instances, the gift giver has some reason or reasons for providing the gift, such as by way of example celebrating a birthday, or in another example a gift given as a wedding gift.

In addition, businesses often provide gifts, such as door prizes, or other items for example as a free item distributed to persons at a trade show, often as part of an advertising or marketing campaign. In some instances, the item or items being distributed will include some type of logo or other markings that associate the item or items with the business making the distribution. These marked items are sometimes referred to as “promotional items” as they are intended to promote some objective, such as to provide advertisement for a given business.

Hereinafter a reference to either a “gift” or a “promotional item” is understood to include the other.

### BRIEF DESCRIPTION OF THE DRAWINGS

The embodiments of the present inventive subject matter are illustrated by way of example and not limitation in the figures of the accompanying drawings, in which like references indicate similar elements and in which:

FIG. 1 is a diagram of a system according to various embodiments;

FIG. 2 is a diagram 100 illustrating an interface screen operable to allow user interface with the gift optimization tool in various embodiments;

FIG. 3 is diagram 11 illustrating information related to a specific product selected from diagram 100;

FIG. 4 is diagram 12 illustrating additional information related to a specific product selected from diagram 100;

FIG. 5 is a diagram 13 illustrating additional information related to a specific product selected from diagram 100;

FIG. 6 illustrates a sample embodiment of pull-down menu choices for “Category” associated with the products or services include in the rows of diagram 100;

FIG. 7 illustrates a sample embodiment of pull-down menu choices for “Who you'll give it to” associated with the products or services include in the rows of diagram 100;

FIG. 8 illustrates a sample embodiment of pull-down menu choices for “Your Image” associated with the products or services include in the rows of diagram 100;

FIG. 9 illustrates a sample embodiment of pull-down menu choices for “Venue for giving it” associated with the products or services include in the rows of diagram 100; and

FIG. 10 illustrates a sample embodiment of pull-down menu choices for “Average Price” associated with the products or services include in the rows of diagram 100.

### DETAILED DESCRIPTION

Although the present inventive subject matter is described below by way of various embodiments that include specific structures and methods, embodiments that include alternative structures and methods can be employed without departing from the principles of the inventive subject matter described herein.

In general, embodiments described below provide various methods for presenting, recommending, selecting or choosing an optimal promotional giveaway or an optimal gift.

Various embodiments include a method of augmenting a product description by assigning to a product a set of values along one or more dimensions that are relevant to the selection of an ideal gift. For example, in the selection of a product to be giveaway as a promotional product, the giver is often interested in conveying a particular image or feeling. In the invention, the product or products to be searched, ranked or considered would be assigned a value to indicate whether, or the degree to which, the product conveyed a particular image or feeling.

In various embodiments, the value assigned can be a binary value, and ordinal value or a continuous value.

Also, various embodiments include apparatus and methods for scoring one or more promotional giveaway items or services, and/or for scoring gifts.

In various embodiments, the tool to perform these processes include software applications operated for example but not limited to, one or more web pages, wherein users access the web pages from a user terminal, and interact with the web page by viewing the web pages, sending data to the web pages, and receiving data back for the web page(s) in the process in performing the methods of the invention.

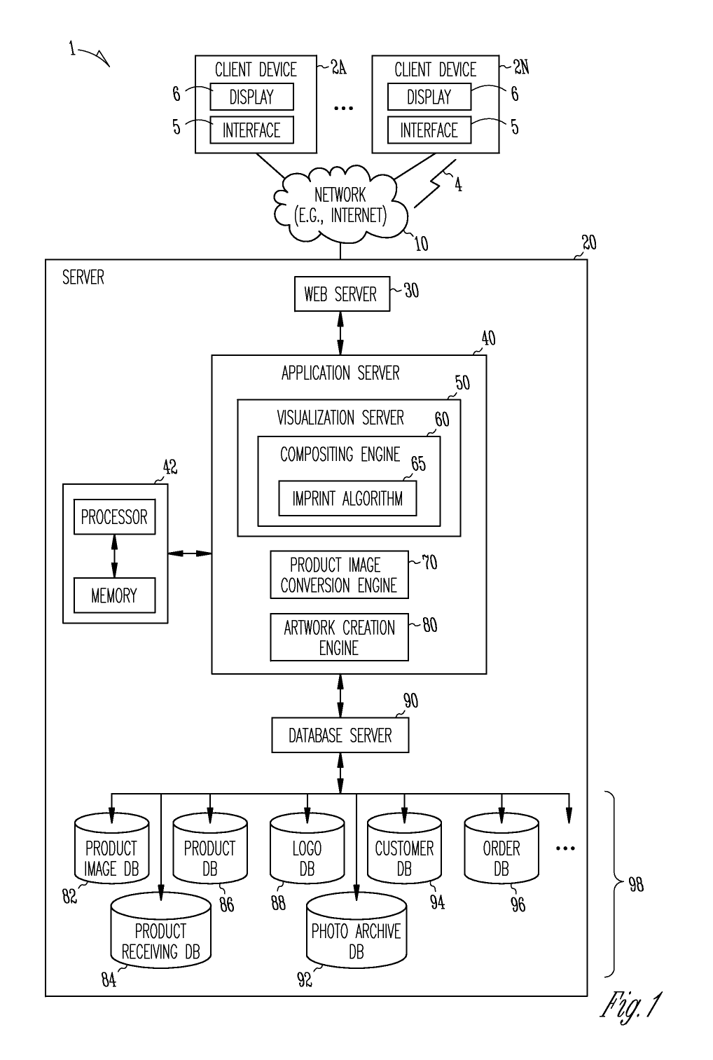

FIG. 1 is a diagram of a system 1 according to various embodiments. System 1 includes one or more client devices 2A-N coupled to server 12 through network 10. Client devices 2A-N are not limited to any particular type of devices. In various embodiments, client devices 2A-N includes a single client device, or a combination of client devices 2A-N. In various embodiments, the single client device or the combination of client devices includes any combination of types of devices, including but not limited to personal computers (PCs), laptop computers, Personal Digital Assistants (PDAs), cellular telephones, Internet Protocol (IP) televisions, and High Definition (HD) televisions.

Client devices 2A-N includes an interface 5. Interface 5 is operable to allow a client device 2A-N to communicate with server 20 through network 10. Interface 5 is not limited to any particular type of interface. In various embodiments, interface 5 is a web browser. In various embodiments, any one or more of client devices 2A-N uses a wireless connection 4 to communicate with network 10. In various embodiments, in instances where a client device included in client devices 2A-N is using the wireless connection 4, interface 5 is operable to facilitate the communications taking place over the wireless connection 4 to and from the given one of client devices 2A-N using the wireless connection 4. It would be understood that the interface 5 in a given client device 2A-N would be operable to allow the given client device 2A-N to communicate with server 20 through network 10, and thus in some embodiments is a different type of interface as would be provided in another and different one of client devices 2A-N.

In various embodiments, client devices 2A-N includes a display 6. Display 6 is not limited to any particular type of display, and can include any type of display operable to visually display some portion of the customized virtual catalog. In various embodiments, display 6 is operable to allow inputs to be made at a client device, by way of illustration but not limited to having display 6 include a touch screen.

In various embodiments, any one of client devices 2A-N is operable to access gift selection tool as provided at server 20. The gift selection tool is not limited to any particular type of tool and can include a tool operable to perform any of the methods and operations described herein, or the equivalents thereof.

In various embodiments, any one of client devices 2A-N is operable to access a gift selection optimization application provided at server 20. In various embodiments, server 20 is operable to provide graphical images included as part of the gift selection optimization application to any one or more of client devices 2A-N. In various embodiments, the gift selection optimization application is provided as one or more web pages accessible by one or more of client devices 2A-N. In various embodiments, server 20 is operable to provide a different and customized virtual catalog to each of the different client devices 2A-N.

In various embodiments, a gift selection optimization application is accessed through one of client devices 2A-N that run interface 5 to provide graphical interfaces for a user to effectively access the customized virtual catalog, including the use of the composite image generation service provided at server 20. The client devices 2A-N communicate with the server 20 via a network 10, which in some embodiments includes the Internet. Server 20 includes in various embodiments any combination of such components including a web server 30, an application server 40, and a database server 90. It will be appreciated that these servers can run on other machines that are accessible by server 20.

In various embodiments, database server 90 is coupled to or includes one or more databases 98. Databases 98 include but are not limited to any combination of product image database 82, product receiving database 84, product database 86, logo database 88, photo archive database 92, customer database 94, and order database 96. In various embodiments, databases 98 are also stored at the server 20. However, it would be understood that one or more of databases 98 can be stored at other machines and other servers, and database data can be uploaded to the server 20 when necessary.

The application server 40 contains visualization server 50 that includes compositing engine 60, product image conversion engine 70, and artwork creation engine 80. In various embodiments, compositing engine 60 generates a composite image based on a first image provided as a promotional product in the customized virtual catalog, and a second image associated with a particular user who is accessing the customized virtual catalog. A first image is, for example, uploaded from a product manufacturer and represents a product depicted in the first image. A file associated with the first image is received at a product receiving database 84. The file includes information associated with the promotional product that is associated with the file, including any combination of dimensional information, choices of colors and materials available for the promotional product, information regarding what manufacturing processes are available for decorating the promotional product, warping information related to how to warp a decorative image onto one or more portions of the images of the promotional product associated with the file, and default areas where decorative images can be applied to the images of the promotional product.

In various embodiments, the file is processed by the product image conversion engine 70 for storage in a product database 86. In various embodiments, the file includes data representing one or more images of the promotional product. In various embodiments, the data representing the one or more images of the promotional product are stored in the product image database 82. In various embodiments, the information associated with the file and the promotional product is stored in the product database 86.

The image for the promotional product can be obtained from the any number of sources. For example, an operator of a Web site that is it supported by the server 20 can employ an internal photographic (or art) department that is responsible for generating images of products that are supplied, together with pertinent product information, to the Web site operator by manufacturers of such products. In various embodiments, these internally generated photographs are stored in a photo archive database 92.

In various embodiments, the decorative image, or “second image” is any image that can be stored or uploaded into visualization server 50, and applied in a composite image to an image of at least one promotional product. In various embodiments, the decorative images are image files that are uploaded from network 10 and stored in logo database 88. The image files are not limited to any particular type or format of files, and can include any types and formats of files operable to provide data that can be utilized as a decorative image by visualization server 50. In various embodiments, the image file for the decorative image is not limited to any particular format, and in various embodiments, can be any of the following formats: Joint Photographic Experts Group format (.jpg), Microsoft Windows™ Bitmap formatted image (.bmp), and Tagged Image File Format (.tif).

In various embodiments, the artwork creation engine 80 is operable to detect information associated with the image file, such as but not limited to the number of colors and transparent areas included in an image file for a decorative image. In various embodiments, visualization server 50 generates displays of the image files on a special background operable to allow a user to edit the image file. In various embodiments, the image file including the decorative image and any associated decorative file information is stored in the customer database 94 so as to associate the image file and the decorative image with a particular client.

In various embodiments, the second image is modified by the artwork creation engine 80 according to the user's blocks in the Web browser. These image conversion processes are described in detail below. The database server 90 that communicates to the application server 40 contains databases used for the composite image generation. As stated above, the databases may be stored at another machine and accessed by the database server 90. Furthermore, the database server 90 may run at another machine and communicate with the application server 40 via the network 10.

There are various ways in which a giver of, for example, a promotional giveaway item or a gift attempts to determine what the gift is going to be. Often the gift giver will simply shop at a gift store, or any store that the gift giver believes caries items that the gift giver is considering as the possible gift. In addition, the gift giver may search for an appropriate gift on-line using for example Internet searches, either using key words or otherwise, to try to get ideas for a gift. However, these types of searches can be very time consuming, and provide the gift giver with no certainty that the search has been optimized for the gift or type of gift the giver is seeking.

In addition, the gift giver in many instances has to consider the circumstances under which, and the reason why, the gift is being given. And there are multiple factors to be considered when choosing a gift. For example, a birthday gift for one's own child will have a different emphasis than a wedding gift for one's brother or sister. In addition a gift may include more than one recipient, for example, when a company gives the same gift to many of its own employees or customers.

Further in some instances, a gift giver is giving a gift to persons whom the gift giver may not know at all or may not know at the time the gift is chosen. For example, if a prize for a contest of some type is being offered, the ultimate winner of the prize (gift) will likely not be known at the time the prize is chosen. In addition, gifts to be given away for example at a trade show in many cases will be handed out in general to strangers who may be attending the tradeshow but who were unknown to the gift giver (trade show exhibitor) at the time the determination was made as to what the gift is to be.

In almost every instance the cost of the gift is an important factor in choosing what the gift is to be. This can be especially important in instances for example where dozens or hundreds of the gift may be distributed, for example as a handout at a trade show. On the other hand, even when a single gift is being considered, the value of the gift may have an effect on how the gift is perceived for example by both the gift giver and the by the recipient of the gift, and so can be an important factor in selection of a gift.

In general, because of the various circumstances and factors involved in the selection of a gift, the classic methods of searching for and choosing a gift can not only be very time consuming and stressful for the gift giver, but also may not result in the optimization of the gift ultimately selected, and thus the objectives of giving the gift may not in fact be met.

The various embodiments and their equivalents as described herein concern tools and methods that reduce the time and effort required to select a more optimal gift for various circumstances, but also are more likely to result in a gift that is more optimal in view of the objectives of the gift giver and the gifting process.

Various embodiments utilize inventive concepts related to choosing an optimal gift in order to aid a gift giver in the selection of an optimal or more optimal gift for a given set of circumstances, and in general in a less time and less stressful framework compared to various other methods of choosing a gift.

In various embodiments, the process takes into consideration one or more important concepts with respect to make a profile for a successful gift. Five such concepts include:

1. Consideration of the image and feeling the gift giver is trying to convey.
2. The relationship between the gift giver and the recipient(s) of the gift.
3. Setting in which the gift giving is being performed.
4. The type of business (if any) in which the gift giver is engaged.
5. The type of job or business in which the recipient is engaged.

In various embodiments, various rankings and scorings are used for a variety of possible products and/or services that could be a potential gift, and a profile that optimizes and guides the gift giver in arriving at an optimal or near optimal gift or selection of gifts is developed for these various products and/or services.

Using the ranking and scorings, various embodiments provide methods, and in various embodiments, apparatus that can be used by a gift giver to guide the gift giver to a decision about which gift is most appropriate in the gift giver's circumstances or, in a given set of circumstances, the extent to which a variety of gifts are more or less appropriate along one or more dimensions.

In most cases, a gift giver has some reasons or motivation for giving a gift, and often this is associated with a feeling or an image the gift giver wants to convey as part of giving the gift. For example, if a professional such as a doctor decides that he or she would like to provide a gift of some type to each of their regular patients at the end of the year, one criteria that might be important to the doctor is that the gift convey an image of professionalism, because the doctor wants these patients to believe that he or she is a competent and professional when functioning as their physician. In another example, a gift being handed out as an advertisement for a comedy club may want to portray an image of being funny, so the recipient of the gift will believe that going to the comedy club will provide a fun and comedic experience.

The particular images or feelings can be generalized in a plurality of different terms. These terms are not limited to any particular terms, and can include any terms deemed to have value in ranking and scoring various aspects associated with the product and/or serviced be rated. Such terms could also be combined into joint terms.

Terms that could be used for ranking or scoring products or services could include, but are not limited to:

Professionalism

Athleticism

Whimsical

Elegant

Green (Eco-friendly)

Luxurious

Sympathetic

Caring

In various embodiments each of the gifts being rated is assigned a ranking or a score associated with each term or term included in the ranking/scoring list. The ranking or scoring is not limited to any particular means of ranking or scoring, and can be any ranking or scoring that assigns some type of rank or score of the gift relative to a given term or terms. For example a scoring range of 1 to 10 could be used to assign the rank or score associated with a given gift relative to the “professionalism” of the product. Wherein for example a ranking of 1 means little or no professionalism is associated with a given gift, and the number from 1 to 10 representing a continuum of “increasing professionalism” associated with the gift as the number increased to 10, with for example 10 being the highest ranking related to professionalism for a given gift. In another embodiment, a “grade” could be assigned to a given gift that reflects the relationship of the gift to the given parameter, (such as “professionalism”), wherein for example an “A+” rating is the most professional, and an “F” grade indicates the least ranking relative to “professionalism” for a given gift, wherein a grade of “B”, “C” and “D” are possible intermediate ratings for the gift relative to the parameter, for example to professionalism.

It would be understood that each of the terms listed above could be rated on the same ranking or scoring system for each product or service, thus generating a ranking/scoring profile for each gift.

The ranking/scoring profile can then be used to aid a gift giver in locating possible gifts for a given gift giving scenario, and in helping the gift giver determine that they have selected a most or near most optimal gift for the situation the gift is intended for and, likewise, help them avoid gifts that are farther from optimal.

For example a gift giver wants to determine what gift or gifts would portray an image of “professionalism” when given as a gift. By using the scoring assigned to each of the possible products or services associated with “professionalism” as a sorting mechanism, a list of potential gifts that rank highest and/or very high with respect to “professionalism” could be generated and provided to the gift giver for further review.

In various embodiments, the setting in which a particular gift is being given is given a scoring value based on the particular product or service being given. For example, a scoring can be assigned to a given gift relative to how that gift ranks in a situation wherein the gift would be given out at a trade show. This same gift could be assigned a different scoring value when considered for example as a wedding gift. These values assigned for a given gift would then be used to help determine an overall score for the gift when considered in a given set of circumstances, an thus be used to help determine which gift is the optimized gift, or one of a set of optimized gift at should be considered under a particular set of multi-dimensional circumstances.

Further, in combination with the gifts ranked on the basis of the scores the products have been ranked with regards to the image portrayed by the gift (for example, “professionalism”), embodiments of the invention will also sort possible gifts based on a different criteria, for example the setting in which gift is being given, as mentioned. Thus, a gift giver can now ask for a list of potential gifts to be generated that portray “professionalism” and also that would be a gift that has a high score relative to the desirability of the gift to be given out at a trade show. An overall “product fitness” score can also be developed based on a combined scoring for a gift based on both the score for the image portrayed by the gift, and the score associated what giving that gift in a particular setting.

As such, this overall combined “product fitness” score can be used to sort the potential list of gifts and provide the gift giver with a list of gifts that are optimized for the criteria the gift giver has specified. This list is generated and sorted based on an overall score which is generated on a multi-dimensional basis using two or more scores from two or more criteria associated with the gifts, the two or more scores based on different criteria associated with the gift and/or the gift giving process.

It would be understood that the number of criteria used to determine an overall “product fitness” score for a given gift is not limited to any particular number of different criteria, and is not limited to any particular criteria. The number and types of criteria in various methods used to determine and overall “product fitness” score for a gift, can be any number and any criteria deemed useful in providing a method of optimizing the selection of a gift.

In one embodiment, the present subject matter can assist a user in search of one or more suitable promotional products. For example, a user could provide one or more criteria in attempting to locate a promotional product. In one embodiment, a list of optimal gifts based on the overall fitness score, determined in view of the criteria selected by the user is provided, the optimal gifts determined by the gift or gifts having the highest overall ranking for “product fitness” based on the criteria selected by the user.

The present subject matter can include obtaining information from a user, so that a product recommendation can be given. Suitable information to be obtained can include data related to the demographics of the target recipient. Other information can include data related to the time, place, and setting during which the promotional product will be distributed. A promotional product can be recommended that is closely tailored to the situation and needs of the user, based on the information provided by the user. For example, the promotional product recommended can be different based on whether the product will be given at an event, such as trade show or sporting event, or through the mail. The product recommended can be different based on whether the target audience is a group of employees, clients, family or friends. The recommendation can vary based on the age of the recipient or can vary if the ages of a group of recipients vary. The recommendation can vary based on time of year and/or climate.

Receive Search Criteria

In various embodiments, the exchange begins when a search criteria is received. In various embodiments, the search criterion includes a request to provide search results for a promotional product. For example, the search criterion is a request to provide search results for clothing, and specifically a polo style shirt. However, the search criteria is not limited to any particular type of search criteria, including but not being limited to search criteria related to promotional products, and can be any type of search criteria. In various embodiments, the selection of the search criteria can be made using pull-down menus provided in an interactive web page.

Examples of promotional products include decorated items such as coffee mugs, writing instruments such as ball point pens, and T-shirts, polo shirts, or any type of clothing items that are or can be decorated.

Perform Search and Generate an Output

Upon receipt of the search criteria, a search based on the received search criteria is performed, and the results are prepared for presentation as an output of the search results. In addition to the search results, a first follow-up response is also selected, the first follow-up response intended to be provided with the output of the search results.

In various embodiments, the response can include information related to pricing of the item or items being presented in the search result. For example, the response could include an indication of a price per individual unit of the item or items being presented in the search results. In various embodiments, the response could provide pricing information related to prices of the item being present as an output of the search criteria when the item is purchased in quantities of more than one. For example, pricing information could be provided for example, but not limited to, a price per item when the item is purchased in various quantities, such as 10 or more items, 100 or more items, 1000 or more items.

In various embodiments, the response can include information related to the options related to shipping of items, or the availability of other items. For example, in various embodiments the response can include information related to the actual availability of the items at one or more locations within a given distance from a predetermined or otherwise specified location. In various embodiments, the response can include various options for shipping, such as but not limited to overnight, 3-5 days, and 1 to 2 weeks, and can provide pricing for one or more of these shipping options.

In various embodiments, the response can include information related to sales information concerning the items being provided in the output of the search results. For example, the response can include an indication of the ranking of the item with respect to the popularity of the item or items related to other similar items. For example, in the search criteria is for a particular type of polo shirt, the results of that search can be provided along with a response indicating the popularity of the particular type of polo shirt relative to all types of polo shirts available for sale. For example, a response such as “This is our most popular type of polo shirt” could be included with the results. The results could be further limited by additional criteria such as pricing. For example, a response such as “This is our most popular selling polo shirt for all polo shirts priced under $35.” It would be understood that the price amount is not limited to any particular price, or even to a single price, and could be a range of prices instead, such as “This is our most popular selling polo shirt priced between $20 and $30.”

In various embodiments, the response can include a query or additional information not related to the polo shirt itself, but for example to the gift giving process, or to the objectives the gift giver is attempting to accomplish through the gift. For example, in response to a request for a search related to polo shirt, a query such as, “What image would you like your polo shirt to convey to the recipient?” could be included with the search results. In various embodiments, the response could include a list of possible images, for example, “Athletic” or “Professional” that the user could review and possibly choose from in order to help the user in the selection of the optimal gift, in this case a polo shirt.

Other possible responses could be based for example on an inquiry regarding the relationship between the user and the potential recipient of the polo shirt, for example, “Is the recipient a family member, co-worker, or a close friend? Again, any further response to this inquiry could be used to help guide the user to a more optimal selection of polo shirt.

Other possible inquiries include a query regarding the setting in which the polo shirt it to be given, for example, a query such as “Is the polo shirt intended to be a birthday present, part of a team outfit, or as an award of some type?” Another possible inquiry could be to ask the user what type of business (if any) the gift giver is engaged in, or for example what type of business the receipt is engaged in. The answer to these inquires in various embodiments can be used to help further guide the search result for example related to the search for the optimal polo shirt for the given circumstances, and the relationship and relative status of the gift giver and the recipient of the gift.

The returned information is also not limited to providing information, but could be any type of statement related to the items or items being provided as part of the output of the search results. For example, as part of a response provided with the output of the search results, information about what is the most popular or bestselling characteristic related to the item, such as but not limited to color, could be provided.

For example, a response such as “Our most popular color choice for this polo shirt is black.” could be provided. In various embodiments, the response is determined based on a composition of two parity cite. For example, a response such as “Our most popular color choice for this is polo shirt in women's sizes is pink.” Thus, the response is more specifically determined based to two different criteria—most popular color, and specifically the most popular color for women's sizes. It would be understood that the combination of criteria is not limited to any particular criteria or combination of criteria, and can be based on any criteria that might be considered to be helpful or useful related to the item or items being presented as the results of the search criteria.

In various embodiments, the response are iterative, and are manipulated in a way so as to be formulated based on one or more responses provided in reply to the information, questions, or other responses previously provided with an output of a search result or to responses provided following the output of the search results but related to the same chain of exchanges.

In various embodiments, the first request for a search is received, and in response an output of the search results is provided, along with a first response. In reply to these outputs, another response of some type is received. The response is then received, and addition search is performed and the new search results are provided. In addition, another response can also be provided based on the contents of the revised search results, the response to output of the first search results, or both.

As an example, a first request is received related to polo shirts. In response, a search is performed, and an output that includes a listing of various polo shirts is prepared. The prepared listing of results related to polo shirts is then provided as an output, along with a response asking “Is the polo shirt intended to be a gift?” In response to this query, a reply of “Yes” is received, indicating that the polo shirt is intended to be a gift. As a result, a second response is provided as a follow-up based on the answer to the first response, the second response intended to gather more specific information for example he second response could be a question, for example, “Is this for a man or a woman?” In another example, the second question could be for example “Would you like the polo shirt to be monogrammed with the recipient's initials?” It would be understood that the second query is not limited to any particular type of query, and can be determined based on any or all of the outputs and replies previously received related to this change of exchanges.

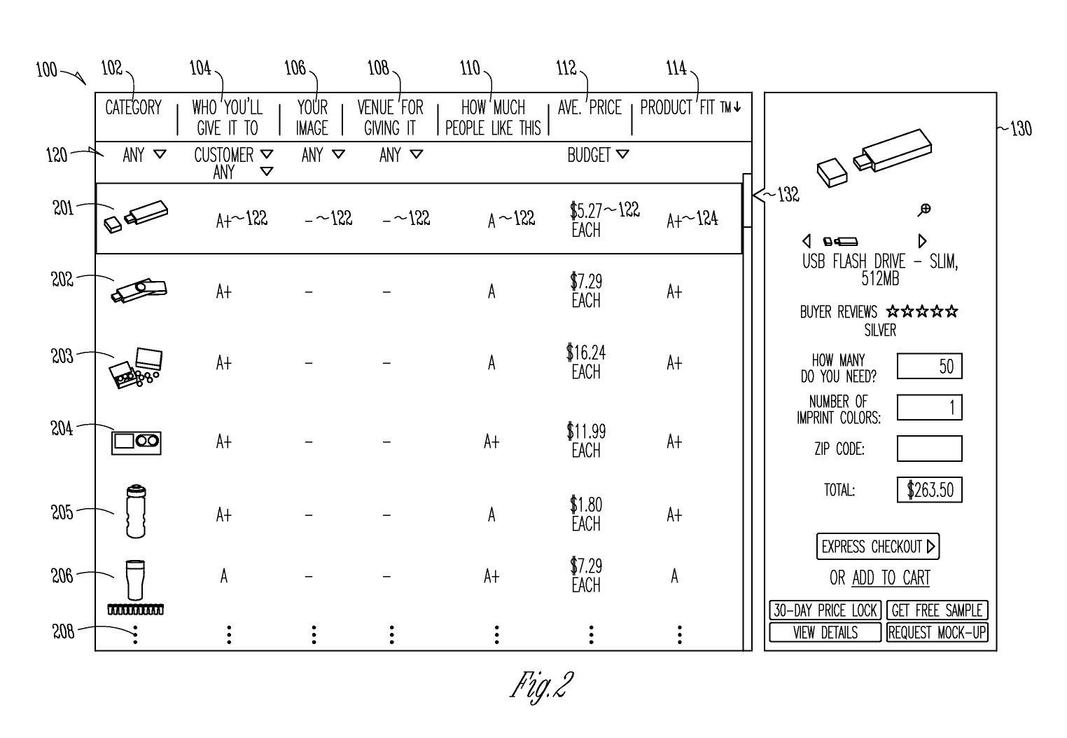

FIG. 2 is a diagram 100 illustrating an interface screen operable to allow user interface with the gift optimization tool in various embodiments. As shown in FIG. 2, diagram 100 includes a series of rows 201-206, and additional row indicated by dots 208. Each of rows 201-206, and any addition row represented by dots 208 represent a single product that is include in a database or databases of available products and/or services. The number of rows is not limited to any particular number of rows, and can be any number of rows based on the number of product and/or services available, or some predetermined number for a given diagram 100.

Each of the rows in diagram 100 extends across a plurality of vertical columns intersecting the row. As shown in diagram 100, the vertical columns include columns 102, 104, 106, 108, 110, 112, and 114, although the number of columns is not limited to any particular number of columns, and my include any number of columns deemed to be desirable or needed for diagram 100.

Each of the vertical columns in diagram 100 has a heading that defines the type of information that is relevant to that particular column. By way of example, vertical column 102 has a heading “Category”, vertical column 104 has a heading “Who you'll give it to”, vertical column 106 has a heading “Your image”, vertical column 108 has a heading “Venue for flying it”, vertical column 110 has a heading “How much people like this”, vertical column 112 has a heading “Avg. Price”, and vertical column 114 has a heading “product fit”.

It would be understood that the heading for these columns is only illustrative, and that any heading could be used for a given column as long at the heading was relevant to the information associated with the particular column where the heading appears.

As shown in diagram 100, under each heading is a row 120 that includes a pull-down arrow operable to be selected, and when selected, provides a pull-down menu of various options that can be chosen to, for example, specifying a list of particular types of information associated with the column heading, as further explained herein.

For each row and its associated products, a “grade box” 122 appears in the row under the associated columns 102, 104, 106, 108, 110, and 112. In the grade boxes, a grading or scoring value may appear, indicating a grade or score for the product associated with that particular row and that associated with the corresponding column for that row. For example, row 201 has a grade “A+” associated with column 104, the column 104 being associated with “Who you'll give it to” and having “customer” selected at row 120.

In various embodiments, the pull-down menus in row 120 may have an option such as “any” available for a given column, and in such instances if “any” is selected, no grade will appear in that specific column in the rows below the column.

As also shown in diagram 100, a grade box 124 is displayed that includes an overall grade associated with the product or service in the corresponding row. For example, for row 201 and at columns “Product Fit”, an overall grade of “A+” appears in the grad box for the product in row 201.

In various embodiments, based on an algorithm using the grades across an entire row for a given product or service, the overall score or overall grade is determined, and the rows 201-206 and additional row 208 are sorted relative to each other based on the score or grade calculated of the “Product Fit” column. By way of illustration, all the products shown in the row 202, 203, 204, and 205 have an “A+” the grade box 124 for each of these products, based in various embodiments on the overall grades in columns 102, 104, 106, 108, 110, and 112, and thus these particular products or gifts are shown as the top row of the list rows in diagram 100.

In various embodiments, sorting to the rows is not strictly limited to being based on the score or grade assigned to the various rows at the “Product Fit” column. For example, in various embodiments, sorting of the rows, or a determination of which row will be displayed at a given time, can be based for example on some algorithms or scheme based on the scores of any of the columns included in the diagram.

In addition, in various embodiments a user can indicate to the diagram which column or columns are more important to the user then other columns. The indication of importance of the column is not limited to any particular method of indicating this relative importance. In some embodiments, the user can simply indicate in the diagram what column is most important to the user. In various embodiments, the diagram is operable to allow a user to indicate a relative weight or importance for one or more, or every column in the diagram. For example the diagram may allow a user to indicate for each column an importance or a weighting for the column by providing a number representative of the column relative importance for one or more of the columns present in the diagram. In various embodiments, the number can be related to some type scale, for example along a scale of 1 to 10. In various embodiments, the calculated rank or score for each row as provided in the “Product Fit” column is weighted based these indications as provided by the user for the other columns in the diagram.

In various embodiments, the display of the items shown in the diagram will be adjusted and/or determined based on these indications for the importance of the columns in diagram, and if these indication are adjusted or changed, in various embodiments the displayed item or the order of the display of these items will also be adjusted in view of these changes.

In various embodiments, in addition to determining the overall grade for a given product and/or service associated with a row based on columns 102, 104, 106, 108, 110, and 112, other grading factors may also be used to determine the final overall grade, such as but not limited to sales figures for a given product or service, trends in sales of a given product or service, or any other factors that may be considered, including any signals that can be used to measure the popularity of a given product or service.

In various embodiments, row 120 is operable to allow a user to choose from the pull-down menus including various categories associated with the column that allows the grading for that characteristic of the product or service associated with each row to be displayed on the screen. By way of illustration, the selection of the characteristic “customer” for the column 104 associated with “Who you'll give it to” results in the grade boxes 122 under column 104 for each row to display a grade or score for each row. In diagram 100, column 106 displays “any” and so no grade appears for the rows under column 106. However, in various embodiments, row 120 allows the listing of choices for “Your image”, and if a choice is in fact selected for this column, diagram 100 is operable to add a showing of a grade or score for each row of products at column 106.

In various embodiments, when a column credential is changed from one category to another, or from “any” to one of the available choices offered from row 120 for that particular column, the scoring for the row appear, and the scoring will also be factored into the overall score calculated for “Product Fit” rank or score shown in column 114. In various embodiments, based on any revisions to the calculated overall score rating for the products as presented in grade box 124, the ordering of the rows within diagram 100 will automatically be rearranged so that the products and services available that now have for example the highest “Product Fit” scores appear at the top of the rows as displayed in diagram 100, for example in rows 201-205 of diagram 100.

By allowing a user to manipulate the criteria in row 120 and to view the resulting product or services now shown in the top row of diagram 100, a tool is provided that allows the diagram 100 to display the most optimal gift to the user based on the user's selectable criteria.

Thus, diagram 100 provides an interactive tool that allows a user to be presented a set of optimized suggestions for gifts based on a set of criteria, wherein the criteria are controllable and amendable by the user on an interactive basis.

Further, the scoring of the product or services used in the database is not limited to any particular system, algorithm, or technique of determining the scores, and can be based on any techniques which are deemed to be useful in the process of guiding a user to an optional gift based on the criteria selected in the columns of the diagram.

The interactive nature and the scoring and sorting of product or services allows a user to quickly test various criteria and receive feedback on various options available for gifts with the added confidence that the gift will achieve the objectives the gift giver intends to achieve by the gift giving process.

In various embodiments, additional information is displayed related to a gift is provided by a display box 130. In In various embodiments, display box 130 displays additional information about at least one of the products or services being shown in one of rows 201-206. By way of illustration, arrow 132 points to row 201 of diagram 100, wherein the product displayed, a USB flash drive associated with row 201 is illustrated in display box 130. Display box 130 is not limited to any particular information, and can include any information rated to the product or service being shown in row 201, including but not limited to pricing and ordering information related to the product or service.

In addition, a picture of the products or service can be included in display box 130, and if the picture is selected by the user, additional screens reacted to the product or service being display at display box 130 can be provide to the user. These additional screens are not limited to any particular types of information, and can be any information related to the product or service that is deemed to be helpful or useful.

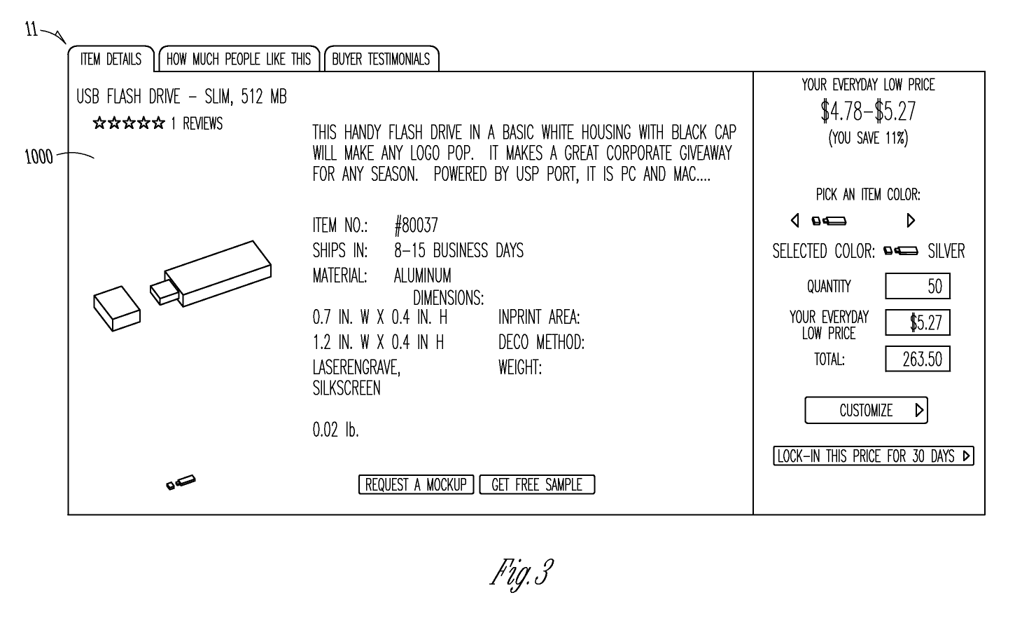

FIG. 3 is a diagram 11 illustrating information related to a specific product 1000 selected from diagram 100. In various embodiments, diagram 11 is provided for display of more detailed information about a particular products associated with one of the products or services presented in a row from diagram 100 of FIG. 2.

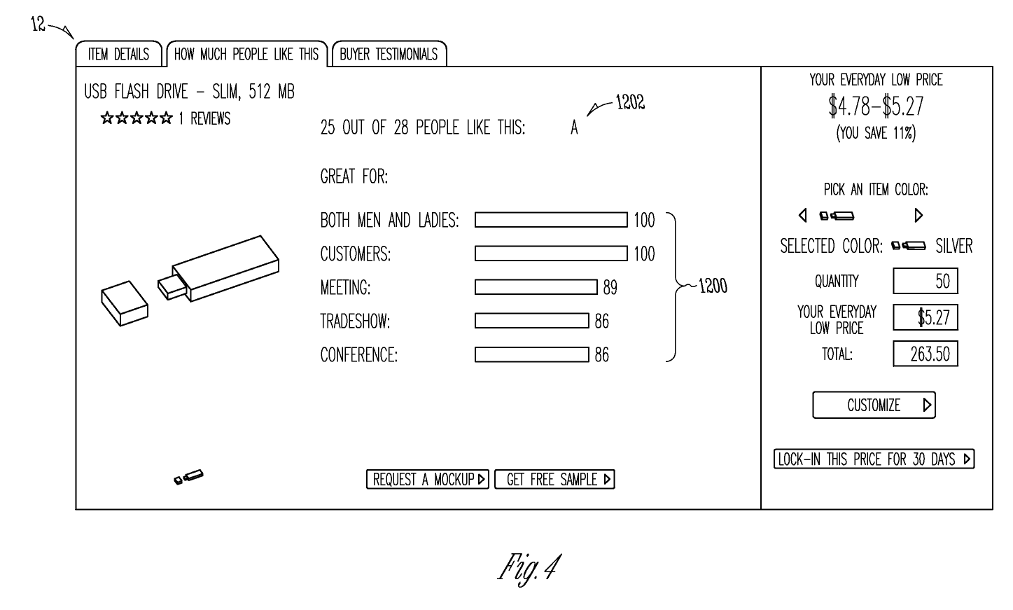

FIG. 4 is a diagram 12 illustrating additional information related to a specific product selected from diagram 100. In various embodiments, diagram 12 is provided for display of information related to “How much people like this” as associated with the product or service being displayed in Diagram 12. In various embodiments, and overall grade or scoring 1202 is displayed for the specific product being displayed in diagram 12. In various embodiments, a set of ratings based on how recipients, or potential recipients of the product being displayed in diagram 12, have rated the product or service. In addition, in various embodiments one or more categories 1200 are provided in diagram 12. These categories are not limited to any particular categories and can be any categories determined to be useful or that might be of interest to a gift give who is considering the items being displayed in diagram 12 as a gift.

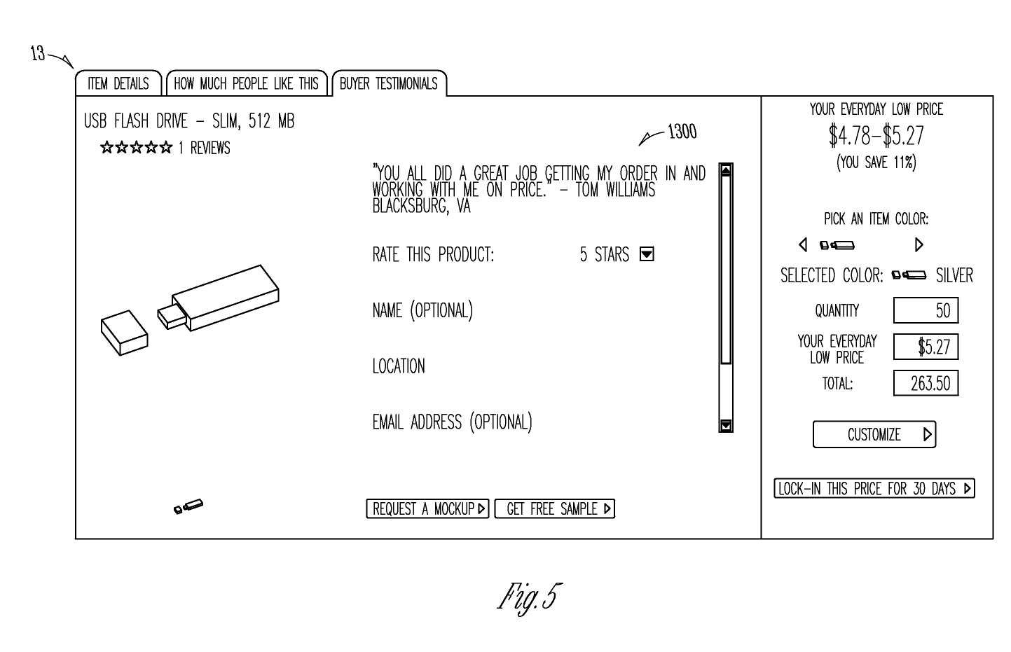

FIG. 5 is a diagram 13 illustrating additional information related to a specific product selected from diagram 100. In various embodiments, “Buyer Testimonials” 1300 can be displayed in diagram 13 that relate to the particular product or service being displayed in diagram 13.

Returning to diagram 100 of FIG. 2, as noted above row 120 includes pull-down menus for the columns 102. 104, 106, 108, 110 and 112, the pull-down menus allowing selection of a characteristics or a parameter associated with the column header.

By way of illustration, and not by way of limitation, the following examples are provided.

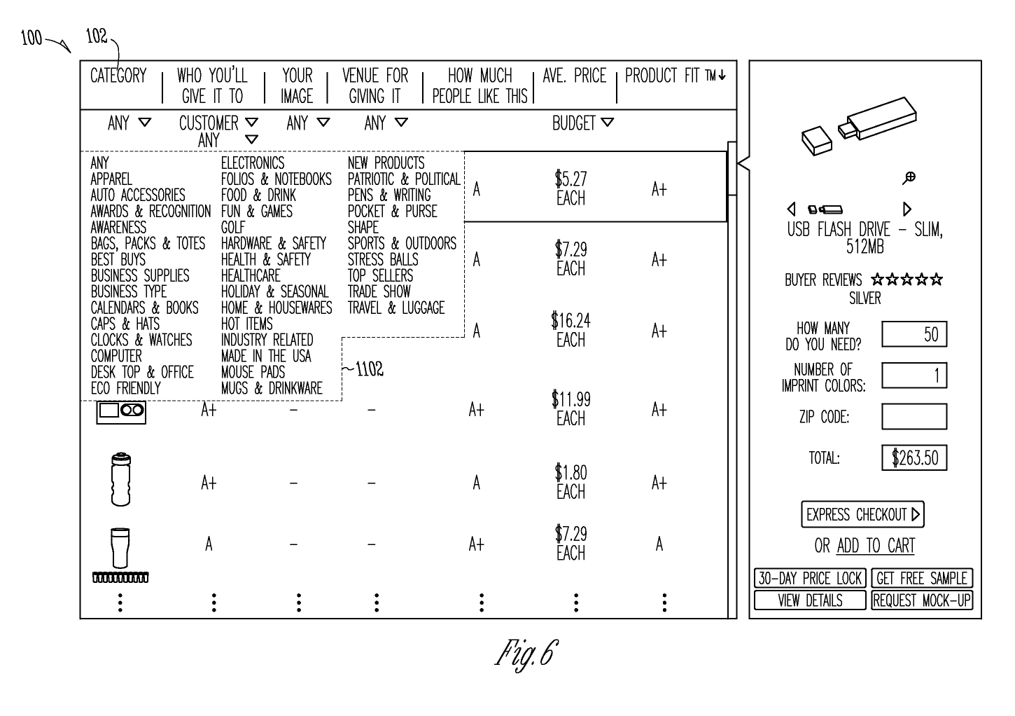

FIG. 6 illustrates a sample embodiment of pull-down menu choices for “Category” associated with the products or services include in the rows of diagram 100. Options of possible choices for “Category” from the pull-down menu are not limited to any particular categories, and by way of example may include “Apparel”, “Awards & Recognition”, “Best Buy”, etc. as show in the list 1102 associated with column 102. If one of these categories is selected, a set of grades or scores will appear in column 102 for all associated products and services available in diagram 100. In various embodiments, based on the selection made from list 1102, a new overall grade for each row in diagram 100 be computed and displayed in grade box 124 of the “Product Fit” column 114. In various embodiments, based on the newly calculated “Product Fit” grade, the rows in diagram 100 will be resorted in their relative order so as to provide the products or services in the row or rows that have for example the highest grade in the “Product Fit” column 114, and thus potentially the most optimal gift in view of the selected criteria, as the top most rows in the diagram 100 being displayed.

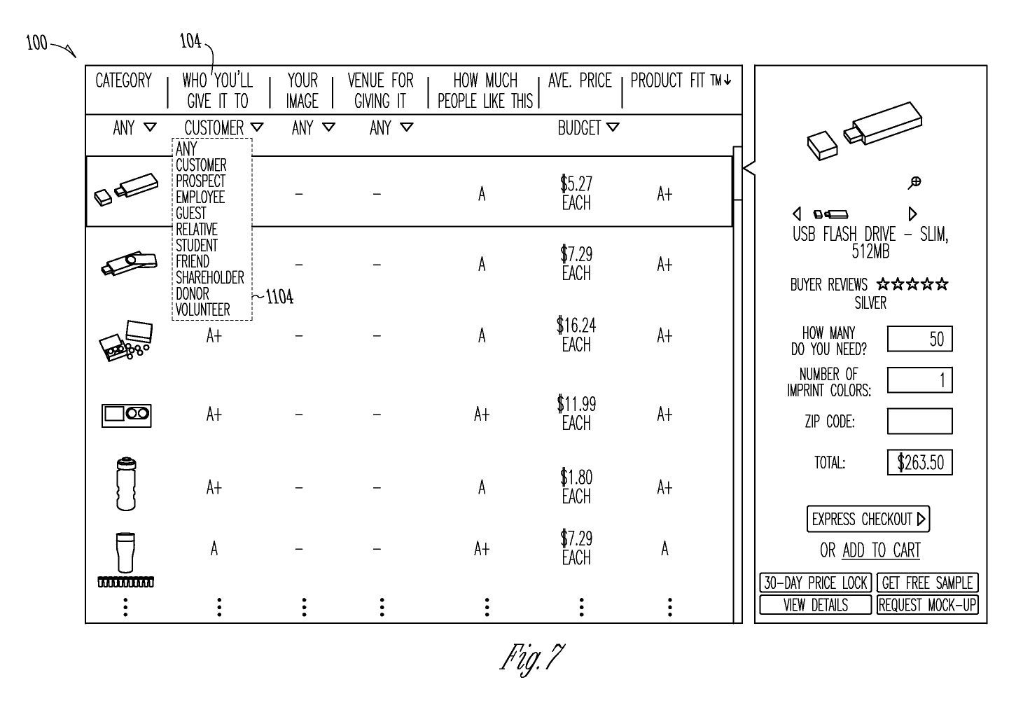

FIG. 7 illustrates a sample embodiment of pull-down menu choices for “Who you'll give it to” associated with the products or services include in the rows of diagram 100. Options of possible choices for “Who you'll give it to” from the pull-down menu are not limited to any party categories, and by way of example may include “Customer”, “Employee”, “Volunteer”, etc. as show in the list 1104 associated with column 104. If one of these choices from list 1104 is selected, a set of grades or scores will appear in column 104 for all associated products and services available in diagram 100. In various embodiments, based on the selection made from list 1104, a new overall grade for each row in diagram 100 will be computed and displayed in grade box 124 of the “Product Fit” column 114. In various embodiments, based on the newly calculated “Product Fit” grade, the rows in diagram 100 will be resorted in their relative order so as to provide the products or services in the rows that have for example the highest grade in the “Product Fit” column 114, and thus potentially the most optimal gift in view of the selected criteria, as the top most rows in the diagram 100 being displayed.

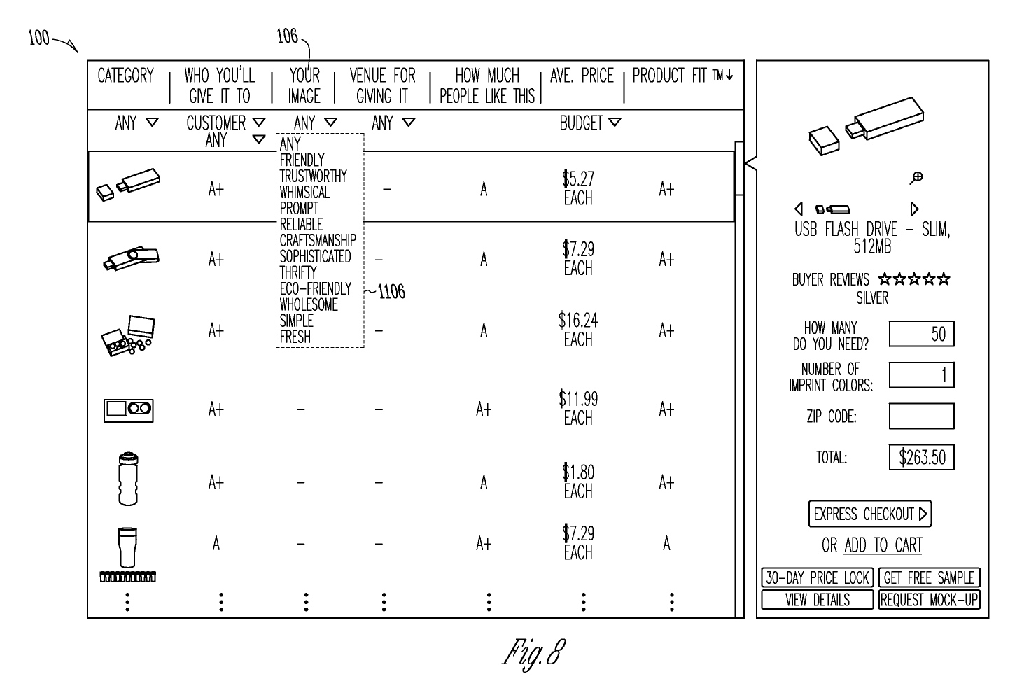

FIG. 8 illustrates a sample embodiment of pull-down menu choices for “Your Image” associated with the products or services include in the rows of diagram 100. Options of possible choices for “Your Image” from the pull-down menu are not limited to any particular parameters, and by way of example may include “Friendly”, “Sophisticated”, “Wholesome”, etc. as show in the list 1106 associated with column 106. If one of these choices from list 1106 is selected, a set of grades or scores will appear in column 106 for all associated products and services available in diagram 100. In various embodiments, based on the selection made from list 1106, a new overall grade for each row in diagram 100 will be computed and displayed in grade box 124 of the “Product Fit” column 114. In various embodiments, based on the newly calculated “Product Fit” grade, the rows in diagram 100 will be resorted in their relative order so as to provide the products or services in the row that have for example the highest grade in the “product Fit” column 114, and thus potentially the most optimal gift in view of the selected criteria, as the top most rows in the diagram 100 being displayed.

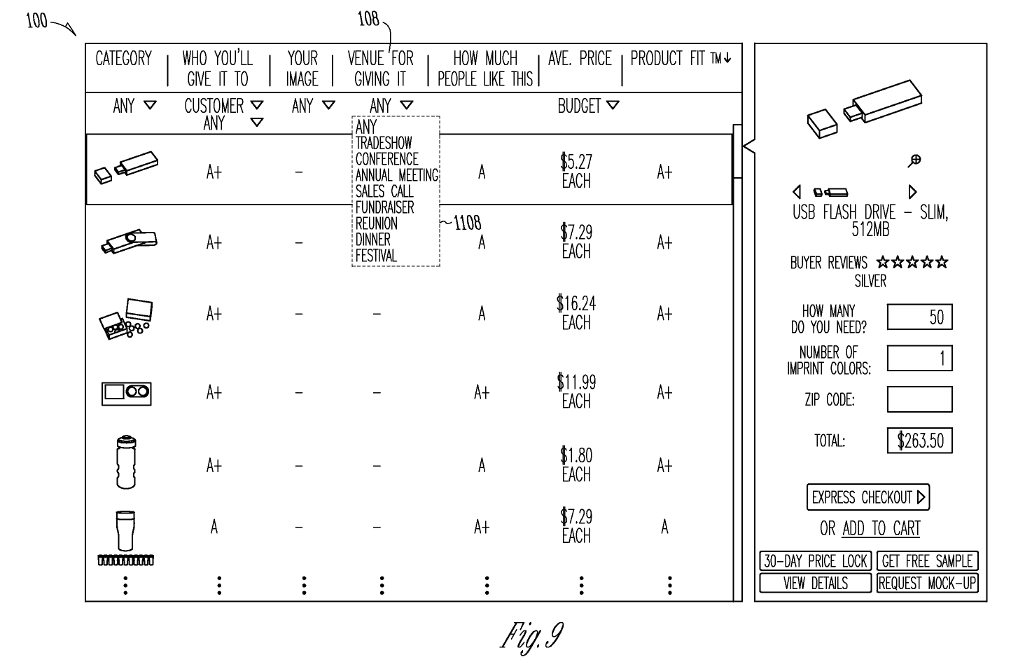

FIG. 9 illustrates a sample embodiment of pull-down menu choices for “Venue for giving it” associated with the products or services include in the rows of diagram 100. Options of possible choices for “Venue for giving it” from the pull-down menu are not limited to any particular parameters, and by way of example may include “Tradeshow”, “Sales Call”, “Reunion”, etc. as show in the list 1108 associated with column 108. If one of these choices from list 1108 is selected, a set of grades or scores will appear in column 108 for all associated products and services available in diagram 100. In various embodiments, based on the selection made from list 1108, a new overall grade for each row in diagram 100 will be computed and displayed in grade box 124 of the “Product Fit” column 114. In various embodiments, based on the newly calculated “Product Fit” grade, the rows in diagram 100 will be resorted in their relative order so as to provide the products or services in the row that have for example the highest grade in the “product Fit” column 114, and thus potentially the most optimal gift in view of the selected criteria, as the top most rows in the diagram 100 being displayed.

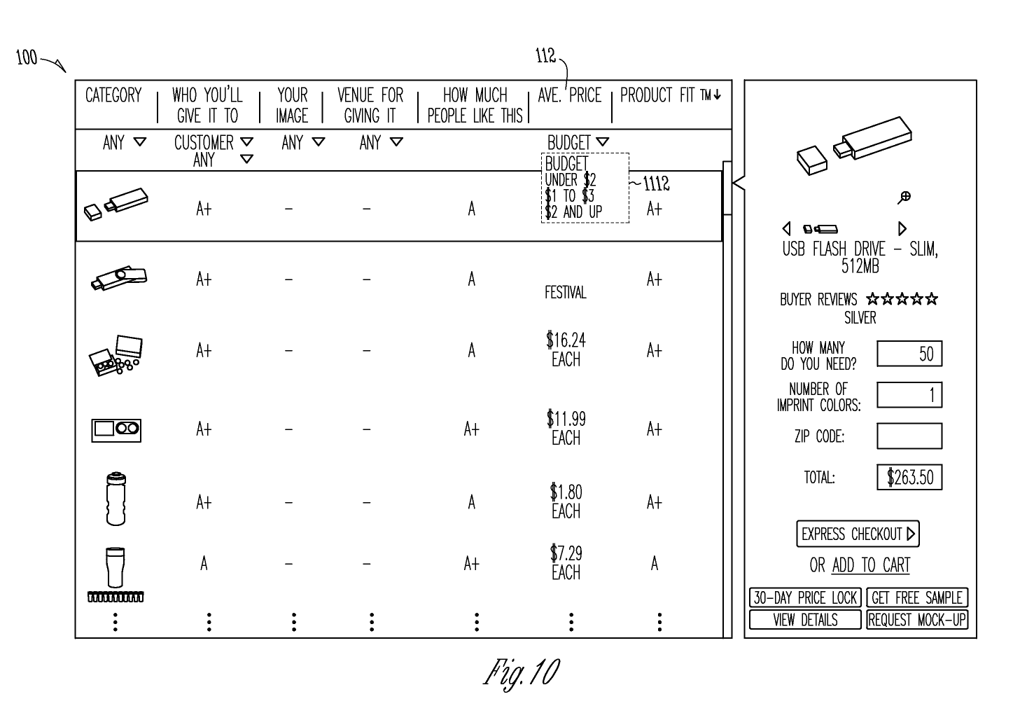

FIG. 10 illustrates a sample embodiment of pull-down menu choices for “Average Price” associated with the products or services include in the rows of diagram 100. Options of possible choices for “Average Price” from the pull-down menu are not limited to any particular parameters, and by way of example may include “any price range or ranges, which may or may not overlap, an in various embodiments an option for entry of a value to be used as a “budget”, etc. as show in the list 1112 associated with column 114. If one of these choices from list 1112 is selected, a set of grades or scores will appear in column 114 for all associated products and services available in diagram 100. In various embodiments, based on the selection made from list 1112, a new overall grade for each row in diagram 100 will be computed and displayed in grade box 124 of the “Product Fit” column 114. In various embodiments, based on the newly calculated “Product Fit” grade, the rows in diagram 100 will be resorted in their relative order so as to provide the products or services in the row that have for example the highest grade in the “product Fit” column 114, and thus potentially the most optimal gift in view of the selected criteria, as the top most rows in the diagram 100 being displayed.

As would be understood, additional changes to any of the choice of the available characteristics can be made using the pull-down menus of row 120 in a continuous interactive manner, wherein as new selections are made from pull-down menus, there is a corresponding recalculation of the overall “Product Fit” score for the gifts, and in various embodiments the reordering of the rows of in diagram 100 will automatically occur based on the new selections and the resulting recalculated overall scores for the gifts.

Thus, diagram 100 provides and interactive tool that allows a user to be presented with optimal gift or gift selections based on the one or more selections of criteria associated with gifts and objectives associated with the gift giving process.

Various embodiments include a program or programs stored on a non-transitory machine readable computer medium, that when executed by a processor, perform one or more in any combination of the methods described herein.

What is claimed is:

1. A method comprising:
presenting gifts based on a multi-dimensional set of parameters, and
wherein each parameter within the multi-dimensional set of parameters is assigned a grade or scoring value for a given product.

2. A method comprising:
sorting a plurality of gifts to determine an optimal gift based on the score of that gift along one or more dimensions assigned to each of the gifts within the plurality gifts,
wherein the value or score assigned to at least one of those dimensions is based, at least in part, on how a set of potential recipients of the gift, or proxies for potential recipients, have rated the gift along one or more dimensions.
